(19) United States
(12) Patent Application Publication
(10) Pub. No.: US 2011/0297727 A1
(43) Pub. Date: Dec. 8, 2011

(54) PLUG GUIDE FOR A NAILING DEVICE AND A DEVICE COMPRISING THE PLUG GUIDE

(75) Inventors: Patrick HERELIER, Saint Jean de Muzols (FR); Guy JAILLET, La Roche de Glun (FR)

(73) Assignee: SOCIETE DE PROSPECTION ET D'INVENTIONS TECHNIQUES SPIT, BOURG LES VALENCE (FR)

(21) Appl. No.: 13/155,030

(22) Filed: Jun. 7, 2011

(30) Foreign Application Priority Data
Jun. 8, 2010 (FR) 1002417

(51) Int. Cl. B25C 5/00

(52) U.S. Cl. 227/139

(57) ABSTRACT

The plug guide comprises a bore for receiving a nail comprising a head and a shaft onto which a skirt is slid, the bore having a passing section determined so that the head and the skirt of the nail cause it to be guided therein, a recess being provided in the front part of the plug guide for ejecting and expanding the guiding skirt. The recess comprises at least one radial bulge projecting inside, for extending the wall of the bore of the plug guide and forming a narrowing for guiding the nail. This invention further relates to a fastening device comprising the plug guide.

The field of this invention is that of nailing devices for fastening nails in a supporting material. These are devices allowing nails to be driven by means of a driving piston, being in turn propelled by an electric, pneumatic or thermal motor.

Today, such devices are most often devices with internal combustion engine, with a combustible gas.

Such devices have, at the front, what is referred to as a muzzle-bushing—in fact a plug guide—that should be in abutment against the supporting material for being able to actuate them. This is the so-called abutment safety. But, such a plug guide also has the function of guiding nails up to the supporting material.

For being properly guided in the gun of the devices as well as in the plug guide, nails are guided in two axially separated areas, the first, at the level of the head thereof, having the same diameter as the bore (of the gun) and of the plug guide, the second, at the level of a guiding skirt slid around the stem thereof and in abutment against the wall of the bore.

In order to better implement the ejection and the expansion of the skirt of the nails going out of the devices, it has been suggested to recess the front end of the plug guides.

But for solving such a problem, another one has been created. With such a recessed structure, the head of nails is no longer guided on the very last portion of the stroke thereof, just before the supporting material, when it opens out in the recess of the plug guide. This is damaging to the fastening safety.

The invention of the present application aims at globally overcoming this latter problem without, on the other hand, giving up solving the first one.

Thus, this invention relates to a plug guide of a nailing device, comprising a bore for receiving a nail comprising a head and a shaft onto which a skirt is slid, the bore having a passing section determined so that the head and the skirt of the nail cause it to be guided therein, a recess being provided in the front part of the plug guide for ejecting and expanding the guiding skirt, said plug guide being characterized in that the recess comprises a narrowing with the same passing section as the receiving bore, whereby the nails remain guided in the bore of the plug guide until they go out of it.

The narrowing is advantageously formed by at least two radial bulges being diametrically opposed when there are only two, at 120° one relative to the others when they are three.

This invention further relates to a nailing device comprising a plug guide, such as claimed-herein above.

This invention will become more obvious reading the following description of the plug guide and of the fastening device of this invention, referring to the appended drawing, in which:

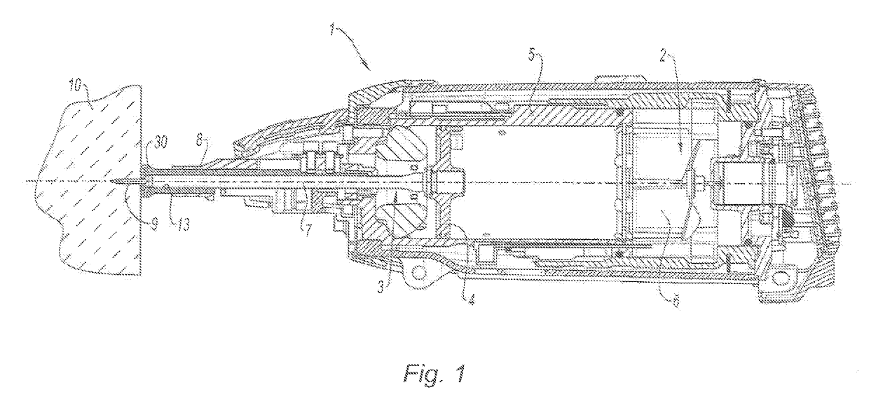

FIG. 1 shows an axial sectional view of a nailing device provided with a prior art plug guide, upon a shot, the nail being almost at the stroke end;

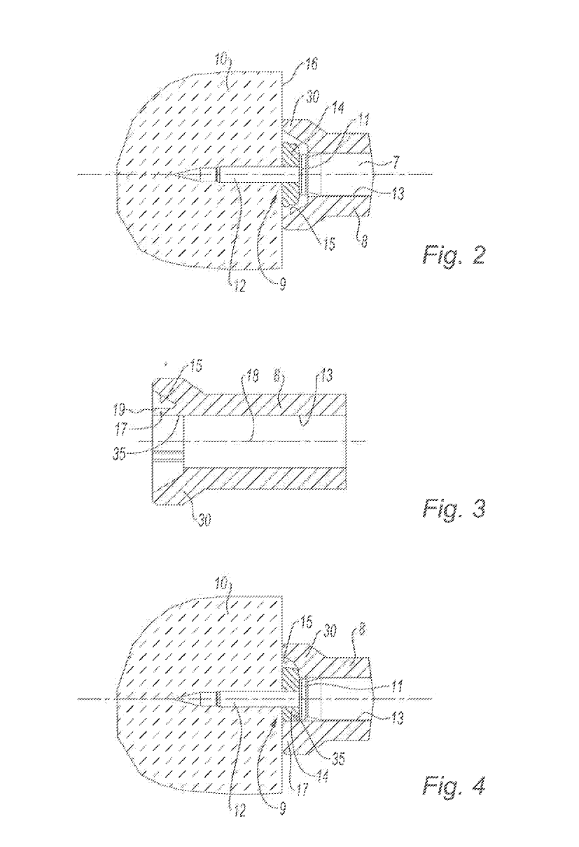

FIG. 2 shows an enlarged view of the front part of the plug guide in the device of FIG. 1;

FIG. 3 is a very large scale sectional view of the front part of a plug guide of this invention;

FIG. 4 is a sectional view of the front part of the plug guide of FIG. 3, upon a shot, the nail being almost at the stroke end;

FIG. 5 is a perspective view of the plug guide of this invention, in an embodiment with three narrowing bulges; and

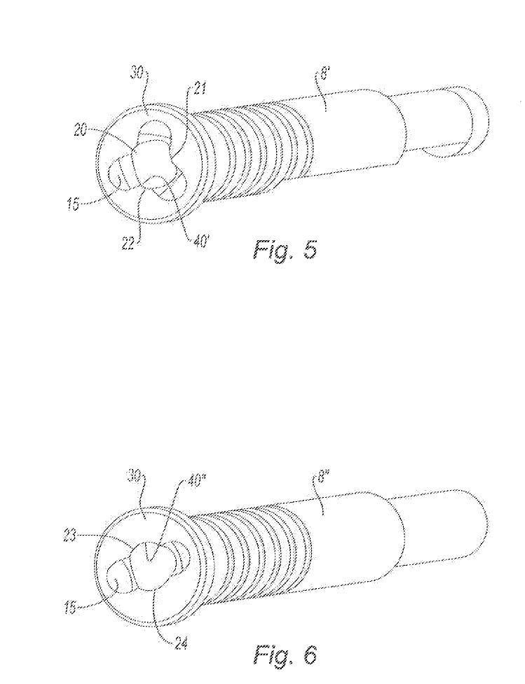

FIG. 6 is a perspective view of the plug guide of this invention, in an embodiment with two narrowing bulges.

Referring to FIG. 1, a prior art nailing device 1, here with an internal combustion engine 2, comprises a driving piston 3, with a head 4 able to be moved into a cylinder 5 under the action of the ignition of the fuel in the chamber 6 of the device.

The piston shaft 7, at the end of the shot, is engaged in the plug guide 8 after having propelled the nail 9 into the supporting material 10 adapted to receive it. The nail 9 comprises a head 11 and a shaft 12. The head 11 has a diameter substantially equal to that of the bore 13 of the plug guide 8.

A guiding skirt 14 is arranged on the shaft 12 of the nail. While the nail is shifted in the plug guide 8, the skirt comes in abutment against the wall of the bore 13 so as to guide the nail. In the front part 30 of the plug guide 8, there is provided a frustoconical recess 15 for ejecting and expanding the skirt 14. Such a front part is flared towards the front.

In the position of FIGS. 1 and 2, the nail 9 is not completely driven yet in the material 10. The guiding skirt 14 has gone out of the part of the plug guide 8 with a section corresponding to that of the nail head 11. The skirt 14 was able to expand before the head 11 of the nail crushes it against the supporting material and that is thus able to be ejected when the operator will get the device out of abutment against the material 10. In the position of FIG. 2, the nail head has just gone out of the bore 13, with a determined and constant section and, between such a position and the complete driving of the nail, until the head 11 comes against the surface 16 of the material 10, the nail is no longer guided.

Referring to FIG. 3, where identical references show the same means as on FIGS. 1 and 2, there can be seen in the sectional plane being considered a radial narrowing bulge 17 of the wall of the recess 15 projecting inside, towards the axis 18 of the plug guide, for extending the wall of the bore 13 of the plug guide, extending behind the recess 15, up to the front end 19 of the plug guide 8. Although this is not the case in practice, even if there is only this one radial bulge 17 and at least this one, the nail head 9 would still, during its stroke through the recess 15 and along such a partial narrowing 35, be guided at least partially, both at the level of the head 11 thereof as at the level of the guiding skirt 14 thereof, as can be seen on FIG. 4.

In practice, the recess 15 actually comprises a narrowing 40 with the same passing section as the bore 13 for receiving the nail and in fact comprises several radial bulges.

As far as the plug guide 8′ of FIG. 5 is concerned, the narrowing 40′ is formed by thee radial bulges 20-22 angularly spaced apart, two by two by 120°.

On the plug guide 8″ of FIG. 6, the narrowing 40″ is formed by only two diametrically opposed radial bulges 23, 24.

There could be more of them, but not too many, so that the recess 15 for expanding and ejecting the guiding skirt of nails remains.

1. A plug guide of a nailing device for fastening nails, comprising a bore for receiving a nail comprising a head and a stem onto which a skirt is slid, the bore having a passing section determined so that the head and the skirt of the nail cause it to be guided therein, a recess being provided in the front part of the plug guide for ejecting and expanding the guiding skirt, said plug guide being characterized in that the recess comprises at least one radial bulge projecting inside so as to extend the wall of the bore of the plug guide and form a narrowing for guiding the nail.

2. A plug guide according to claim 1, wherein the recess comprises a narrowing with the same passing section as the bore for receiving the nail.

3. A plug guide, according to claim 2, wherein the narrowing is formed by two diametrically opposed radial bulges.

4. A plug guide, according to claim 2, wherein the narrowing is formed by three radial bulges, angularly spaced apart, two by two by 120°.

5. A nailing device for fastening nails comprising a plug guide according to claim 1.
